(19) United States
(12) Patent Application Publication
(10) Pub. No.: US 2008/0160177 A1
(43) Pub. Date: Jul. 3, 2008

(54) METHODS FOR ELECTROLESS PLATING OF METAL TRACES ON A SUBSTRATE AND DEVICES AND SYSTEMS THEREOF

(76) Inventors: J. C. Mataybas, Chandler, AZ (US); Lakshmi Supriya, Chandler, AZ (US); Omar Bchir, Chandler, AZ (US)

Correspondence Address: INTEL/BLAKELY, 1279 OAKMEAD PARKWAY, SUNNYVALE, CA, 94085-4040, US

(21) Appl. No.: 11/618,528

(22) Filed: Dec. 29, 2006

(51) Int. Cl. B05D 5/12

(52) U.S. Cl. 427/98.5; 427/304; 427/305; 708/100

(57) ABSTRACT

Methods for forming traces/lines and interconnects on substrates and devices and systems thereof of herein disclosed. In some embodiments, an activator layer is deposited on a surface of a substrate. Pick-up lithography using a pre-patterned lithographic stamp, ultraviolet lithography or like methods are used to selectively remove portions of the activator layer to form a pattern on the surface of the substrate. Electroless metal deposition is then applied to the surface of the substrate to form a metal pattern selectively on the remaining activator layer. Electroless plating can then be used to form traces/lines and interconnects in dimensions of less than 10 micrometers.

### FIELD OF INVENTION

Line/interconnect fabrication for package substrates.

### BACKGROUND OF INVENTION

Circuit dies or chips are commonly provided as individual, pre-packaged units. A typical chip has a substantially flat, rectangular body with a front face having contacts for connection to internal circuitry of the chip. An individual chip is typically mounted to a substrate or chip carrier (substrate package or support circuit), that in turn is mounted on a circuit panel such as a printed circuit board

In order to provide electrical connectivity between the chip and the circuit panel, lines, traces or interconnects (hereinafter referred to interchangeably) may be formed within the chip carrier. Current methods to form lines and interconnects involve a semi-additive process. In one process, a dielectric layer of a substrate is seeded with a catalyst (e.g. Pd) followed by electroless copper deposition (FIG. 1A). A photoimaging agent, such as photoresist, is then deposited and patterned to expose selective areas on the surface of the substrate using ultraviolet radiation (FIG. 1B). Thereafter, copper is electrolytically deposited wherein the copper plates on exposed selective areas only (FIG. 1C). Following electrolytic copper deposition, the photoresist can be stripped and the substrate can be etched to isolate the electrolytically deposited copper (FIG. 1D). The process described is relatively complex and costly, and typically includes about 10 percent (%) of the cost of a 6-layer substrate, such as a 2-2-2 bismaleimide triazene (BT) substrate, and increases with increasing layer count.

In lieu of the process described, using a patterned stamp to fabricate patterned lines and interconnects has been attempted. In one method, a surface of a substrate was chemically modified prior to applying a prepatterned stamp “inked” with an activator onto the surface of the substrate to selectively deposit the activator onto the substrate. In another method, a prepatterned stamp was inked with activator particles, heated and pressed onto a heated polymer. The activator particles were selectively transferred onto the polymer surface and an electroless deposition process was subsequently performed. The surface of the heated polymer in this method was not chemically modified. See Ng, W. K., Microcontact printing of catalytic nanoparticles for selective electroless deposition of metals on nonplanar polymeric substrates, App. Phys. Lett. 2002, vol. 81, No. 16. The methods described require great control over the adhesion properties of the activator to the stamp and the surface of the substrate leading to greater complexity.

### BRIEF DESCRIPTION OF DRAWINGS

FIGS. 1A-1D is a cross-sectional view of a substrate subjected to a semi-additive metal deposition process.

FIG. 2A is a cross-sectional view of an embodiment of a substrate prior to a metal deposition process using a pre-patterned lithographic stamp or UV lithography.

FIG. 2B is a cross-sectional view of the substrate of FIG. 2A after deposition of an activator on a surface of the substrate.

FIG. 2C is a cross-sectional view of the substrate of FIG. 2B with the pre-patterned lithographic stamp positioned above the surface of the substrate before contact with the surface.

FIG. 2D is a cross-sectional view of the substrate of FIG. 2C with a pre-patterned lithographic stamp positioned above the surface of the substrate after contact with the surface.

FIG. 2E is a cross-sectional view of the substrate of FIG. 2E after electroless metal deposition on the surface of the substrate

FIG. 3 is a flow chart representing an embodiment of a method of forming metal traces/lines and/or interconnects on a surface of a substrate.

FIG. 4 is a flow chart representing an alternative embodiment of a method of forming metal traces/lines and/or interconnects on a surface of a substrate.

FIG. 5 shows a computer system including microprocessor enclosed by a package mounted to a printed circuit board.

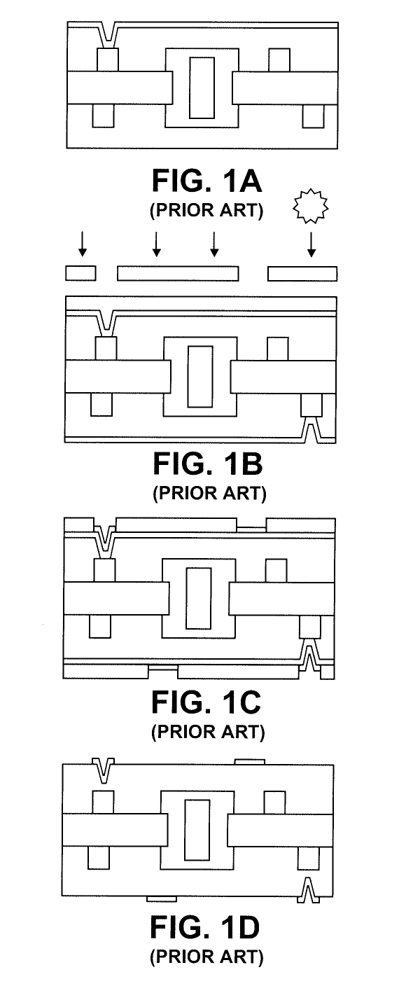

### DETAILED DESCRIPTION

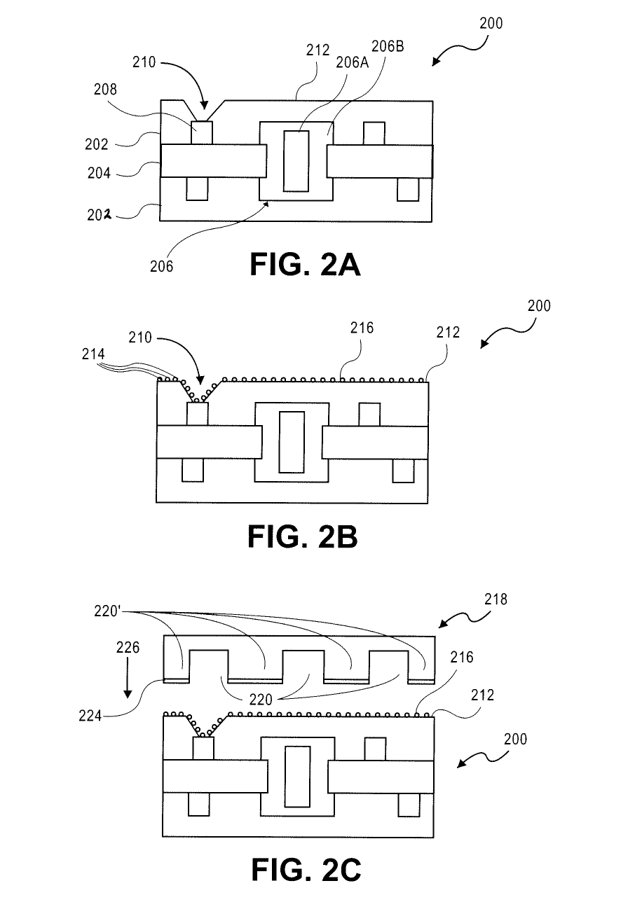

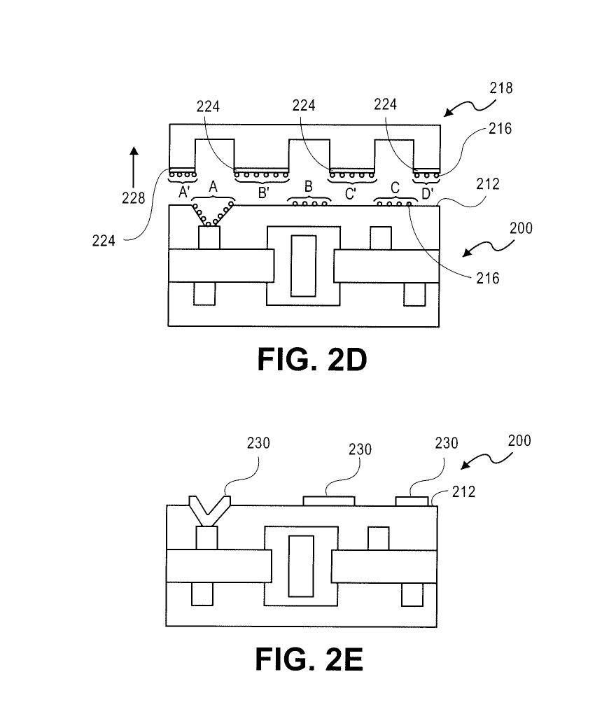

FIG. 2A is a cross-sectional view of an embodiment of a substrate which may be fabricated according to an embodiment of a method of the invention. Substrate 200 includes core material 204, which can be, for example, a fiberglass reinforced epoxy dielectric material. Adjacent to core material 204 are layers 202 which can be a dielectric material and is typically not fiberglass-reinforced. Within substrate 200, a plurality of plated through-holes (PTH) are dispersed throughout the substrate core 204. A PTH is a through hole wherein the through hole wall has a coating or lining of conductive material. The conductive lining electrically bridges conductors on one side of the through hole with conductors on the other side the through hole. The PTHs must be electrically isolated from each other, where required, to prevent shorting. PTH 206 is representative of a plated through hole within substrate 200. PTH 206 may include a plug 206a, which is surrounded with conductive material 206b. In some embodiments, if the diameter of PTH is small enough, PTH 206 can be completely filled with conductive material 206b (not shown. Substrate 200 also includes a plurality of metal elements 208 dispersed throughout for electrical bridging between a chip (not shown) and a circuit panel (not shown). Metal elements 208 can be lines, traces or interconnects. In this embodiment, substrate 200 also includes at least one microvia 210 for connecting metal element 208 in order to form an interconnect. In this embodiment, the bottom of microvia 210 is the top surface of metal element 208.

Microvia 210 can be formed by a number of suitable methods. For example, microvia 210 can be formed by laser drilling or by carbon dioxide laser ablation. Representatively, microvia 210 can be between about 50 μm and 120 μm. Thereafter, surface 212 of substrate 200 can be subjected to a desmearing process. In a desmearing process, a “sweller” material can be applied to surface 212 to increase the surface area in preparation for etching. After swelling, an etchant such as potassium permanganate (KMnO₄) may be used to remove the smear and etch the dielectric surface. As a result, surface 212 of substrate 200 becomes rough.

FIG. 2B is a cross-sectional view of substrate 200 of FIG. 2A after deposition of activator 214, or catalyst, has been deposited on surface 212 of substrate 200. In addition to being deposited on surface 212 of substrate 200, activator 214 is also deposited on the sidewalls of via 210 and the top surface of metal element 208. Activator 214 may be a metal, such as, for example, platinum, palladium, gold, palladium/tin, an alloy thereof, or any other metal or metal alloy with properties similar to those listed. In some embodiments, the metal may be deposited from a solution containing the metal in a cationic state. The cationic metal (deposited on surface 212) must subsequently undergo chemical reduction in order to form the elemental metal thereby forming activator layer 216.

Activator 214 may be deposited by various processes including, but not limited to, dip-coating, spin-coating or brushing. “Dip-coating” refers to the immersing of a substrate into a tank containing coating material, removing the piece from the tank, and allowing it to drain. “Spin-coating” is a procedure in which an excess amount of the solvent is placed on a substrate, which is then rotated at high speed in order to spread the fluid by centrifugal force. Rotation is continued while the fluid spins off the edges of the substrate, until the desired thickness of the film is achieved. The applied solvent is usually volatile, and simultaneously evaporates. The higher the angular speed of spinning, the thinner the film. The thickness of the film also depends on the concentration of the solution and the solvent. For example, activator layer 216 may be between 10 nanometers (nm) and 40 nm. Activator 214 forms activator layer 216 on surface 212 of substrate 200 as well as the sidewalls of via 210 and the bottom of via 210.

FIG. 2C is a cross-sectional view of substrate 200 of FIG. 2B with a pre-patterned lithography stamp 218 positioned in proximity to surface 212 of substrate 200. Stamp 218 can have a plurality of recessed portions 220 and a plurality of corresponding jutting portions 220′. In some embodiments, stamp 218 may have a predetermined pattern which will be a pattern that is opposite to the eventual resultant interconnect/line. For example, if the desired pattern on substrate 200 includes areas A, B and C, then stamp 218 will have corresponding recessed portions A′, B′ C′ and D′ (see FIG. 2D). Stamp 218 may be made of an elastomer, such as polydimethylsiloxane and/or fluorosilicon, or a metal, such as aluminum, nickel or stainless steel. In some embodiments, a stamp made of elastomer is more advantageous for applications on non-planar surfaces. Stamp may be of a size suitable for imprinting a pattern on a substrate, or about 10 mm to 500 mm. Stamp 218 may be manufactured using a process such as, for example, ultraviolet (UV) lithography, etching or like processes.

According to some embodiments, the surface of jutting portions 220′ of stamp 218 may by coated with an adhesive 224. Generally, the adhesive has a property which causes the adhesive to have an affinity for activator 214. In some embodiments, the adhesive has an affinity for activator 214 through a chemical interaction. Examples of these types of adhesives include alkyl thiols, alkoxysilanes, carboxyls and amines. In other embodiments, the adhesive has an affinity for activator 214 by physical means, analogous to “glue”. Examples of these types of adhesives include epoxy resins. In yet other embodiments, the adhesive has an affinity for activator 214 through physical and chemical interactions, such as, for example, ionic interactions or van der Waals forces. Examples of these types of adhesives include silicon dioxide in a polymer/solvent matrix and titanium dioxide in a polymer/solvent matrix. In one embodiment, silicon dioxide (SiO₂) in methanol or ethanol is added to a polymer such as epoxy resin, poly(methyl methacrylate) (PMMA) or polyester. Generally, the adhesive can be any other chemical or matrix which has an affinity for activator 214.

In some embodiments, stamp 218 can be physically contacted with surface 212 of substrate 200 (arrow 226). Enough pressure should be applied to initiate contact between adhesive 224 and activator layer 216; however, too much pressure may result in an undesirable result. That is, the pressure should be controlled such that only jutting portions 220′ of stamp 218 come into contact with surface 212 of substrate 200. Due to the interaction between adhesive 224 and activator layer 216 (as discussed previously), jutting portions 220′ of stamp 218 may selectively “lift” activator 214 in substantially or completely all portions 220′ that come into direct contact with activator 214 when stamp 218 is lifted from surface 212 of substrate 200 (arrow 228). The result may be a “pattern” of left-over activator 214 on surface 212 of substrate 200. FIG. 2D, which is a cross-sectional view of substrate 200 of FIG. 2C, shows stamp 218 being removed from surface 212 of substrate 200 after adhesive 224 has selectively lifted portions of activator 214 adhering to jutting portions 220′. In other words, areas A′, B′, C′ and D′ of stamp 218 selectively remove activator 214 in those areas that come into contact with activator 214. The result is activator 214 remaining on corresponding areas A, B and C on surface 212 of substrate 200. In some embodiments, activator 214 is substantially or completely removed from surface 212 and only remains on the sidewalls of via 210 and the top surface of metal element 208 only. In this embodiment, pinch-off may be substantially avoided in subsequent electroless plating processes. According to some embodiments, selective lift-off of activator 214 may be done to one surface at a time to prevent substrate warpage issues which may affect lift-off capability.

In an alternative embodiment, in lieu of stamp 218, ultraviolet (UV) lithography can be used to create a patterned area on substrate 200. For example, a UV source can be used in conjunction with a photomask to selectively remove portions of activator 214 from surface 212 of substrate 200, forming a pattern of activator 214 thereon. It should be appreciated that other processes may be used to form a pattern on a surface of a substrate in preparation for subsequent metal deposition to form lines/traces and interconnects.

FIG. 2E is a cross-sectional view of substrate 200 of FIG. 2D after an electroless metal deposition process, i.e., electroless plating, has been applied to surface 212 of substrate 200. “Electroless plating” is the deposition of metals on a catalytic surface from solution without an external source of current. The object desired to have a selective coating(s) of a metal thereon is immersed in a bath containing various reagents, such as stabilizers and chelating agents. In electroless plating, metal ions are reduced to a metal only on a specific surface in which the catalyst resides. Electroless plating generally results in conformal deposition. According to some embodiments, electroless plating of substrate 200 after selective “lift” of activator 214 results in metal deposition of corresponding areas A, B and C (on which remains activator 214) on surface 212 of substrate 200. In some embodiments, the metal is aluminum, an aluminum-silicon alloy, an aluminum-copper alloy or copper. In one embodiment, copper is used due to its low electrical resistivity. According to some embodiments, the metal layer 230 can be between about 10 μm and 15 μm in thickness.

Although electroless plating is generally a slower process compared to electrolytic plating, several “fast” electroless copper plating chemistries have recently been reported wherein the deposition rate is as high as 10 μm per hour. For example, a deposition rate of greater than 8 μm/hr for electroless bath with a pH of 13 and a temperature of 50° C. using ethylenediaminetetraacetic acid (EDTA) complexing agent with cytosine or benzotriazole as the stabilizer has recently been reported. See Hanna, F. et al., Controlling factors affecting the stability and rate of electroless copper plating 2003 Mat. Lett. 58, 104-109. Use of 2-mercaptobenzothiazole as the stabilizer increased the deposition rate above 10 nm/hr. Other industrially-based EDTA-based electroless bath chemistries include CP-251 (available from Rohm and Haas, Pennsylvania, U.S.A.), which is reported to give a deposition rate of approximately 5 μm/hr and PTH BLG or Printoganth P and PV (available from Atotech, Berlin, Germany), which is reported to give a deposition of approximately 7.5 μm/hr. Any of the above discussed electroless plating chemistries can be used in accordance with embodiments with the invention; however, these chemistries are in no way limiting.

Subsequent to the initial electroless deposition, a second electroless plating process can be applied to surface 212 of substrate 200 to form interconnects or traces/lines. The traces/lines can be from about 1 μm to about 10 μm. Thereafter, known process for deposition and patterning of subsequent dielectric layers for form openings for interconnects between layers can be performed.

### EXAMPLE

In one embodiment, a surface of a substrate can be dip-coated in solution containing gold particles. A patterned stamp coated with n-alkylthiol is stamped on the surface of the substrate. The gold particles in contact with the stamp are “pick-up” upon removal of the stamp from the surface, whereas the gold particles remain on the surface in the other regions. Electroless copper deposition is performed on the entire surface leaving copper coated on the gold-coated regions.

### EXAMPLE

In one embodiment, a surface of a substrate can be dip-coated in solution containing palladium particles. A patterned stamp coated with an adhesive, such as an epoxy-based or acrylate based adhesive, is stamped on the surface of the substrate. The palladium particles in contact with the stamp are “pick-up” upon removal of the stamp from the surface, whereas the palladium particles remain on the surface in the other regions. Electroless copper deposition is performed on the entire surface leaving copper coated on the palladium-coated regions.

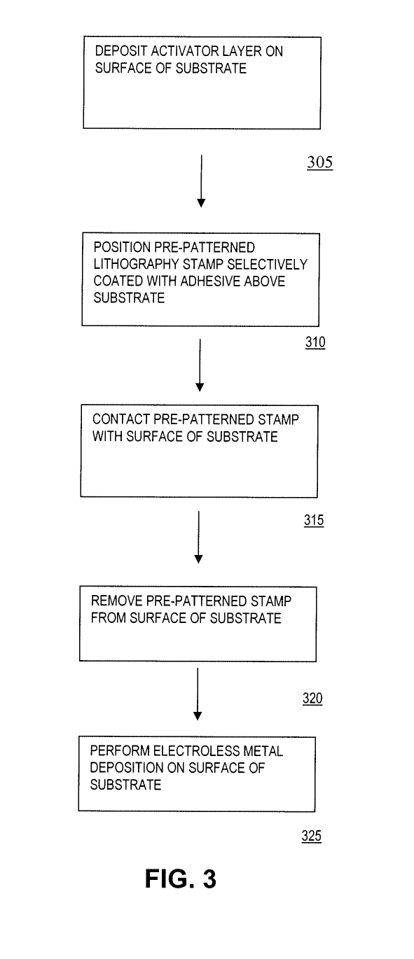

FIG. 3 is a flow chart representing an embodiment of a method of forming metal traces/lines and/or interconnects on a surface of a substrate. An activator layer is deposited on a surface of a substrate having at least one microvia and prepared for electroless deposition by, for example, desmearing (305). A pre-patterned lithography stamp selectively coated with adhesive on at least one jutting portion is positioned above the substrate (310). The jutting portions of the stamp are contacted with the activator layer on the surface of the substrate (315). The stamp is then removed from the surface of the substrate, leaving activator on non-contacted portions of the surface of the substrate and removing activator on contacted portions of the surface of the substrate (320). An electroless metal deposition process is performed on the surface of the substrate wherein the metal is only deposited on the non-contacted portions of the surface of the substrate in which activator continues to reside (325).

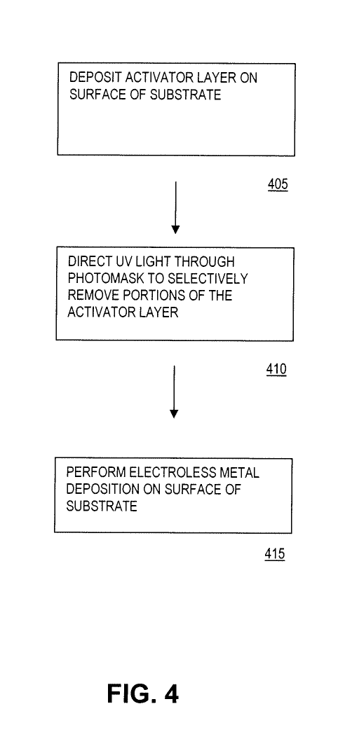

FIG. 4 is a flow chart representing an embodiment of an alternative of forming metal traces/lines and/or interconnects on a surface of a substrate. An activator layer is deposited on a surface of a substrate having at least one microvia and prepared for electroless deposition by, for example, desmearing (405). UV light is directed to the surface of the substrate through a photomask to selectively remove at least some portions of the activator layer (410). An electroless metal deposition process is performed on the surface of the substrate wherein the metal is only deposited on the non-contacted portions of the surface of the substrate in which activator continues to reside (415).

Substrates formed by embodiments of methods of the invention, described previously, can be used to fabricate substrates according to current design rules, as well as substrates and with traces/lines and/or interconnects below 10 μm. Additionally, substrates formed by embodiments of methods of the invention can be used to prepare packaging architecture including, but not limited to, flip-chip line grid array (FC-LGA), flip-chip ball grid array (FC-BGA), flip-chip pin grid array (FC-PGA), wire-bonded molded matrix array package (WB-MMAP), chip-scale package (CSP), stacked CSP, folded CSP, thin small outline package (TSOP) and very thin fine pitch BGA (VF-BGA). It should be appreciated that this list is exemplary and in no way limiting.

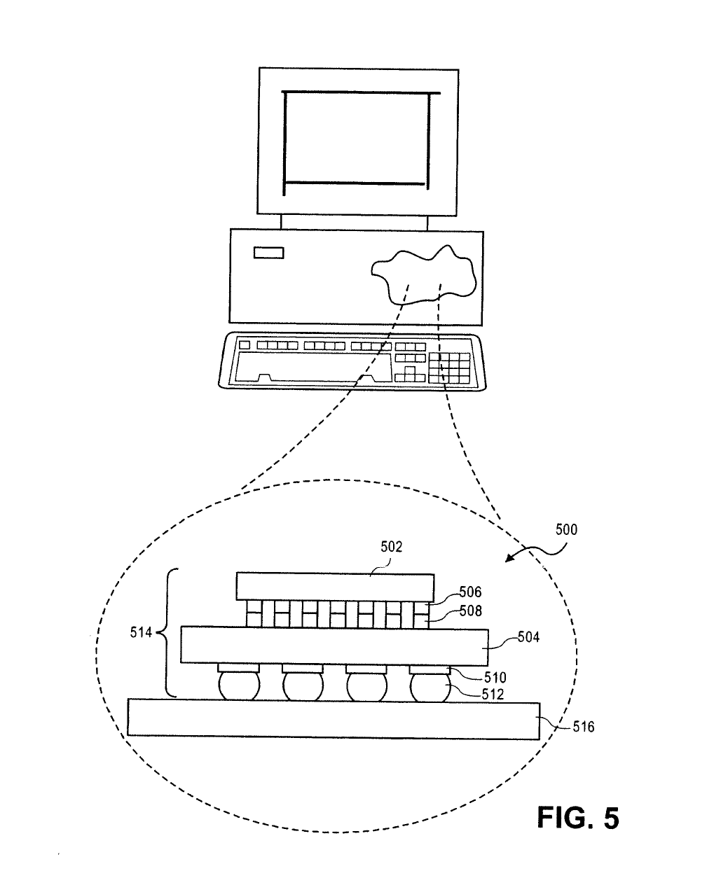

FIG. 5 shows a cross-sectional side view of an integrated circuit package that is physically and electrically connected to a printed wiring board or printed circuit board (PCB) to form an electronic assembly. The electronic assembly can be part of an electronic system such as a computer (e.g., desktop, laptop, handheld, server, etc.), wireless communication device (e.g., cellular phone, cordless phone, pager, etc.), computer-related peripheral (e.g., printer, scanner, monitor, etc.), entertainment device (e.g., television, radio, stereo, tapes and compact disc player, video cassette recorder, motion picture expert group audio layer 3 player (MP3), etc.), and the like. FIG. 5 illustrates the electronic assembly as part of a desktop computer. FIG. 5 shows electronic assembly 500 including die 502, physically and electrically connected to package substrate 504. Die 502 is an integrated circuit die, such as a microprocessor die, having, for example, transistor structures interconnected or connected to power/ground or input/output signals external to the die through interconnect lines to contacts 506 on an external surface of die 502. The die may be formed in accordance with known wafer processing techniques. Contacts 506 of die 502 may be aligned with contacts 508 making up, for example, a die bump layer on an external surface of package substrate 504. On a surface of package substrate 504 opposite a surface including contacts 508 are land contacts 510. Connected to each of land contacts 510 are solder bumps 512 that may be used to connect package 514 to circuit board 516, such as a motherboard or other circuit board.

In the foregoing specification, specific embodiments have been described. It will, however, be evident that various modifications and changes can be made thereto without departing from the broader spirit and scope of the appended claims. The specification and drawings are, accordingly, to be regarded in an illustrative rather than a restrictive sense.

What is claimed is:

1. A method comprising:
depositing an activator on a surface of a substrate;
selectively removing portions of the activator to leave a predetermined pattern of the activator on the surface of the substrate; and
immersing the substrate in an electroless plating bath, wherein a first metal in the bath is selectively deposited on the predetermined pattern of activator.

2. The method of claim 1, wherein the activator is one of platinum, palladium, gold or palladium/tin.

3. The method of claim 1, wherein selectively removing portions of the activator comprises physically contacting the activator with a prepatterned stamp.

4. The method of claim 3, wherein the prepatterned stamp is coated with an adhesive.

5. The method of claim 4, wherein the adhesive is one of an alkyl thiol, an alkoxysilane, a carboxyl, an amine, an epoxy, silicon dioxide in a polymer/solvent matrix, titanium dioxide in a polymer/solvent matrix, or another adhesive material with similar properties.

6. The method of claim 1, further comprising depositing a second metal on the substrate, wherein the second metal is selectively deposited on the first metal.

7. The method of claim 1, wherein the first metal is one of aluminum, an aluminum-silicon alloy, an aluminum-copper alloy or copper.

8. The method of claim 6, wherein the second metal is one of aluminum, an aluminum-silicon alloy, an aluminum-copper alloy or copper.

9. The method of claim 6, wherein the second metal is deposited by electroless plating.

10. The method of claim 1, wherein selectively removing portions of the activator comprises removal by ultraviolet lithography using a photomask.

11. The method of claim 1, wherein the substrate is one of flip-chip line grid array, flip-chip ball grid array, flip-chip pin grid array, wire-bonded molded matrix array package, chip-scale package, stacked chip-scale package, folded chip-scale package, thin small outline package or very thin fine pitch.

12. A method comprising:
depositing an activator on a surface of a substrate;
selectively removing portions of the activator with a prepatterned stamp to leave a predetermined pattern of the activator on the surface of the substrate; and
immersing the substrate in an electroless plating bath, wherein a copper layer is selectively deposited on the predetermined pattern of activator.

13. The method of claim 12, wherein the activator is one of platinum, palladium, gold or palladium/tin.

14. The method of claim 12, wherein selectively removing portions of the activator comprises physically contacting the activator with the prepatterned stamp.

15. The method of claim 12, wherein the prepatterned stamp is coated with an adhesive.

16. The method of claim 15, wherein the adhesive is one of an alkyl thiol, an alkoxysilane, a carboxyl, an amine, an epoxy, silicon dioxide in a polymer/solvent matrix, titanium dioxide in a polymer/solvent matrix, or another adhesive material with similar properties.

17. The method of claim 12, further comprising depositing a second layer of copper on the substrate, wherein the second layer of copper is selectively deposited on the first layer of copper.

18. The method of claim 17, wherein the second copper layer is deposited by electroless plating.

19. The method of claim 12, wherein the surface of the substrate includes at least one via.

20. The method of claim 19, wherein at least a portion of the predetermined pattern corresponds to the via.

21. The method of claim 12, wherein the substrate is one of flip-chip line grid array, flip-chip ball grid array, flip-chip pin grid array, wire-bonded molded matrix array package, chip-scale package, stacked chip-scale package, folded chip-scale package, thin small outline package or very thin fine pitch.

22. A system comprising:
a computing device comprising:
a microprocessor;
a printed circuit board; and
a substrate, wherein the microprocessor is coupled to the printed circuit board through the substrate, the substrate comprising an interconnect formed from an electroless plating of a conductive material on a stamped pattern on a surface of the substrate.

23. The system of claim 22, wherein the interconnect comprises copper.

24. The system of claim 22, wherein the substrate is one of flip-chip line grid array, flip-chip ball grid array, flip-chip pin grid array, wire-bonded molded matrix array package, chip-scale package, stacked chip-scale package, folded chip-scale package, thin small outline package or very thin fine pitch.
